(19) United States
(12) Patent Application Publication
(10) Pub. No.: US 2012/0016525 A1
(43) Pub. Date: Jan. 19, 2012

(54) ENERGY FORECASTING AND MANAGEMENT DEVICE

(75) Inventor: Paul Shawn Davis, Yucca Valley, CA (US)

(73) Assignee: Attune Rtd, Palm Springs, CA (US)

(21) Appl. No.: 13/182,399

(22) Filed: Jul. 13, 2011

Related U.S. Application Data
(60) Provisional application No. 61/363,973, filed on Jul. 13, 2010.

(51) Int. Cl. G06F 1/28; G05D 7/06; G05D 23/19

(52) U.S. Cl. 700/276; 713/320

(57) ABSTRACT

A system for forecasting demand energy associated with a swimming pool and a home's HVAC unit. The pool has a circulation pump motor and the system records fluctuation in daily ambient air temperature, pool water temperature, psi reading of the pool's circulation system and monitors both the daily run time of the pool pump and the HVAC unit.

### RELATED APPLICATION

This application claims the benefit and priority to U.S. Provisional Application Ser. No. 61/363,973, filed Jul. 13, 2010, the content of which is incorporated by reference herein in its entirety.

### BACKGROUND

1. Field

The invention relates to a system for forecasting demand energy associated with a pool and a home HVAC unit

2. Description of the Prior Art

There is a need to forecast demand energy associated with a swimming pool sump circulation motor and a home HVAC unit.

These and other objects are preferably accomplished by a system which includes

Control unit controls the swimming pool circulation pump/motor. Unit considers fluctuations in daily ambient air temperatures, water temperatures, circulation system psi readings, circulation system gpm readings, to arrive at necessary daily run time of swimming pool circulation pump/motor.

Control unit is connected to a GUI (Web Solution), That allows both the electric utility and consumer to view run times of the pool circulation motor and home HVAC unit in real time (information is passed in fifteen minute intervals). GUI allows the utility to forecast demand energy associated with these devices and interrupt the devices if necessary to relieve demand on the grid. The GUI uses historical data related to average monthly high temperatures for the past thirty years to predict and forecast daily run times of the pool circulation pump/motor.

Actual pool circulation pump/motor run times are determined by the actual daily high ambient air temperature, water temperature, circulation system psi reading, and circulation system gpm readings.

Control unit is equipped with two wireless radios. One is a Zigbee radio that communicates with the utility smart metering system, and the other is wireless radio that communicates through a GUI.

### DRAWINGS

FIG. 1 of the drawing is a schematic illustration of the system of the invention.

### DETAILED DESCRIPTION

Flow Chart of Daily Operation with Single Speed Motor:

>Units programmed start time energizes the pool circulation pump/motor

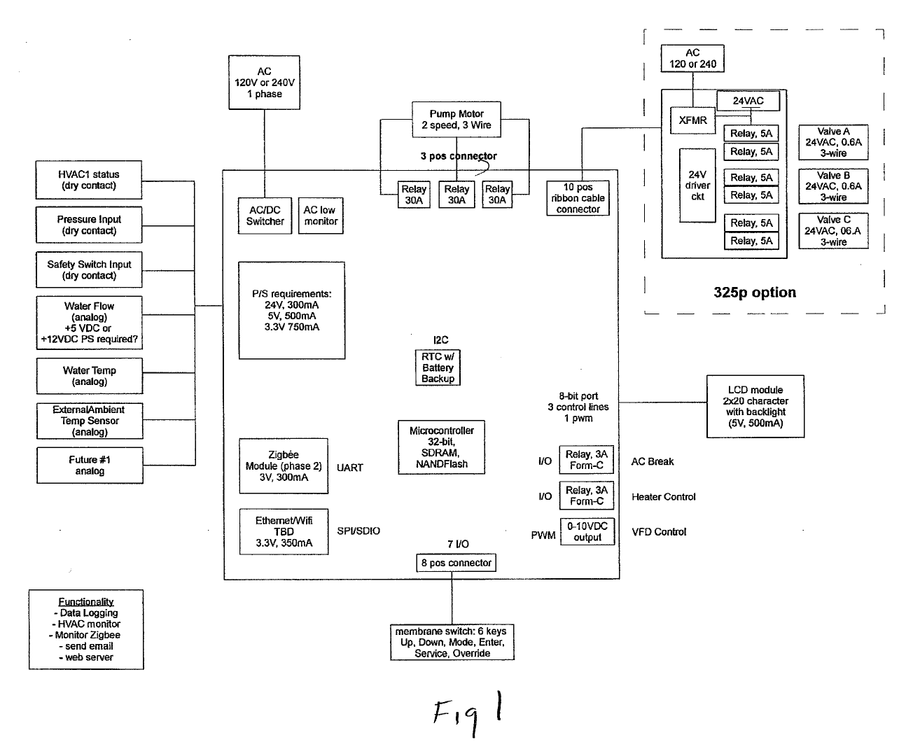

>Unit runs its programmed minimum run time uninterrupted unless other functionality is activated. (See FIG. 1).

>After the minimum run time is accomplished, the unit de-energizes the pool circulation pump/motor and waits to see what the daily high ambient air temperature reached. (See FIG. 1).

1. Ambient Temperature Adjustments Summary

a. Unit monitors ambient temperature, and daily high temperature is determined at 4:00 pm.

b. Unit then runs additional run time based on high daily temperature:

i. Temperature ≦88 degrees

1. operate for minimum programmed run time.

ii. Temperature >88° F. and ≦93° F.

1. operate for minimum run time and an additional 1 hour.

iii. Temperature >93° F.

1. pump operates for maximum programmed run time.

Flow Chart of Daily Operation with Dual Speed Motor:

>Units programmed start time energizes the pool circulation pump/motor

>Unit energizes the pool circulation pump/motor for either one hour in high speed, or two hours in high speed, this time increment is selected by the installer.

>The balance of run time is accomplished in low speed.

>Pool circulation pump/motor runs for twice as long in low speed to accomplish equal circulation in high speed.

### EXAMPLE

*one hour in high=two hours in low

>If pool circulation pump/motor was energized for one hour in high, and the minimum programmed run time was set at four hours, the control unit would then energize the low speed of the pool circulation pump/motor for six hours to accomplish its minimum run time requirement.

>Additional run time that could occur based on the high ambient air temp for the day would be associated with the low speed of the pool circulation pump/motor.

1. Ambient Temperature Adjustments Summary

a. Unit monitors ambient temperature, and daily high temperature is determined at 4:00 pm.

b. Unit then runs additional run time based on high daily temperature:

i. Temperature ≦88 degrees

1. operate for minimum programmed run time.

ii. Temperature >88° F. and ≦93° F.

1. operate for minimum run time and an additional 1 hour.

iii. Temperature >93° F.

1. pump operates for maximum programmed run time.

Flow Chart of Daily Operation with Variable Speed Dual Powered Brushless D.C. Motor:

>Control unit gives priority to solar panel power source in morning and afternoon hours.

>The motor is a brushless D.C. motor designed to be powered by no more than 40 volts D.C.

>The brush less D.C. motor by design is variable speed.

>The control unit reads GPM and calculates amount of water filtered.

>At 4:00 pm the control unit compares the daily high ambient air temperature, and determines if there needs to be additional circulation of pool water. This is accomplished by comparing how much water was circulated by the pool motor/pump by using the solar power source and comparing this to its programmed amount of water to be circulated. If the requirement was reached the control unit does not engage the house/utility power source.

1. Ambient Temperature Adjustments Summary

a. Unit monitors ambient temperature, and daily high temperature is determined at 4:00 pm.

b. Unit then runs additional run time based on high daily temperature:

i. Temperature ≦88 degrees

1. operate to achieve minimum gallons to circulate (one complete turn over)

ii. Temperature >88° F. and ≦93° F.

1. operate to achieve minimum gallons to circulate plus additional 50% turn over.

iii. Temperature >93° F.

1. pump operates to achieve two complete turn over.

>By comparing the amount of water circulated to the programmed daily minimum amount of water to be circulated versus ambient air temperature it may be necessary for the control unit to engage the house/utility power source to power the D.C. motor/pump in order to circulate the proper amount of pool water.

>The brushless D.C. motor is equipped with a transfer switch allowing it to be powered from either solar or house/utility power.

>Interfaced with the house/utility power source is a power supply that converts the 120/240 volt A.C. power to 40 volt D.C.

### Functionality

1. Run Time

a. Uses Start time setting

b. Minimum run time setting (reference 10149A02M)

c. Maximum run time setting (reference 10149A02M)

d. Unit will run programmed minimum runtime

e. After minimum runtime is achieved, unit checks for daily high temperature.

i. Refer to Ambient Temperature Adjustment Summary, below

2. Motor Type

a. Single Speed

i. Unit runs when HVAC unit is off. (if interrupt is active)

ii. Unit is off when HVAC unit is on. (if interrupt is active)

b. Dual Speed

i. Unit is programmed to either run pump for one or two hours in high speed

ii. Unit runs balance of time in low speed

3. Load Management

a. HVAC Input

i. Start time

1. HVAC input becomes active

2. Control unit begins acting on recognition of HVAC input to ground.

4. Peak Hour Interrupt

a. Peak Hour Start Time

b. Peak Hour End Time

c. When Peak hours is active I on, control unit will not allow pool pump to be energized.

i. Service mode may override to force pool pump on

5. HVAC override

a. HVAC Enable Start Time

b. HVAC Enable End Time

c. Enable

i. If enabled, and between the appropriate start and end times, the unit monitors the HVAC1 input for a constant run time of forty-five minutes. After 45 minutes, the control unit will begin to interrupt the HVAC thermostat (via the HVAC Override relay). HVAC override will monitor the HVAC1 dry contact input to allow a run time ratio of 15 minutes on to 5 minutes off.

ii. HVAC on=NC contacts closed (allows 24 vac from thermostat to HVAC)

iii. HVAC off=NC contacts open (breaks 24 vac to HVAC)

iv.

6. Pressure Switch

a. Pressure switch is normally open

i. Pressure switch is adjustable 0-35 psi.

b. When contact closure occurs

i. Dual speed motor

1. The control unit only allows the low speed of the motor to be energized. High speed is not allowed in this case

2. Over pressure alert should be displayed on the front panel.

ii. Single speed motor

1. Pressure switch closure does not affect normal pump operation.

2. Over pressure alert should be displayed on the front panel.

7. Peak Hours Minimum Run Time

a. If enabled

i. If unit does not run for at least 2 hours during the hours of 10:00 am-6:00 pm and ambient temperatures were equal to or greater than 98° F., the unit will add an additional hour of run time to maximum run time setting.

8. Vacuum Switch Input

a. Vacuum Switch setting is adjustable.

b. Dry contact

i. Normally open

c. When contact closure occurs:

i. Pool pump motor is de-energized for 10 seconds.

ii. After 10 seconds unit will energize pool pump motor.

iii. If vacuum switch is still closed unit will repeat sequence.

9. Ambient Temperature Offset

a. Allows user to adjust ambient air temp by +/−maximum number of degrees (reference 10149A02M for limits) to compensate for unit location in direct sunlight or shade.

10. Ambient Temperature Adjustments Summary

a. Unit monitors ambient temperature, and daily high temperature is determined at 4:00 pm.

b. Unit then runs additional run time based on high daily temperature:

i. Temperature ≦88 degrees

1. operate for minimum programmed run time.

ii. Temperature >88° F. and ≦93° F.

1. operate for minimum run time and an additional 1 hour.

iii. Temperature >93° F.

1. pump operates for maximum programmed run time.

11. Daily Run Times

a. all daily run times are based on midnight to midnight

b. any remaining run hours are not rolled over to the next day

12. Run priorities

a. Override has top priority.

b. Service has priority over peak hours and HVAC1 input.

c. Peak hours has priority over run time.

d. Daily run time has priority over HVAC at end of the day in order to reach programmed run time.

e. HVAC can interrupt pool pump when not at risk of not meeting daily run time.

It can be seen that there is described a system for forecasting demand energy associated with a pool and a home HVAC unit. Variations thereof may occur to an artisan and the scope of the invention should only be limited by the scope of the appended claims.

1. A system for forecasting demand energy associated with a swimming pool and a HVAC unit in a home or the like comprising:
Said pool having a circulation system controlled by a pump motor;
Recording means adapted to record fluctuations in daily ambient air temperature surrounding the pool, pool water temperature, psi readings associated with the pool circulation system, and gpm associated with the pool circulation system; and monitoring means coupled to both the recording means and the pump motor to compute the daily run time of said pump motor and control running of the same.

2. The system of claim 1 including a web-based interface coupled to said monitoring means for viewing run times of said pool circulation motor.

3. The system of claim 2 wherein said interface is associated with the owner of said pool.

4. The system of claim 3 where said interface is associated with an electric utility that supplies electricity to the home of said owner.

5. The system of claim 1 wherein both said recording means and said monitoring means are coupled to said HVAC unit.

6. The system of claim 2 wherein said interface is also coupled to said HVAC unit and adapted to interrupt operation of both said pool pump and said HVAC unit if necessary to relieve demand on the grip associated with an electric utility supplying electricity to said home.

7. The system of claim 1 wherein an electric utility provides electricity to said home, the amount of electricity used at said home being monitored by a meter, and a wireless radio communicating with both the meter and said monitoring means.

8. The system of claim 7 wherein a web-based interface is coupled to both said monitoring means and said electric utility by means of a wireless radio.
